(19) United States
(12) Patent Application Publication
(10) Pub. No.: US 2023/0380547 A1
(43) Pub. Date: Nov. 30, 2023

(54) BUCKLE

(71) Applicant: WOOJIN PLASTIC Co., Ltd., Namyangju-si (KR)

(72) Inventors: Ji Sook PAIK, Seoul (KR); Nan Hee PAIK, Seoul (KR); Ji Hye PAIK, Seoul (KR); Ji Won SON, Seoul (KR)

(73) Assignee: WOOJIN PLASTIC Co., Ltd., Namyangju-si (KR)

(21) Appl. No.: 17/970,721

(22) Filed: Oct. 21, 2022

(30) Foreign Application Priority Data
May 31, 2022 (KR) 10-2022-0066501

(51) Int. Cl. A44B 11/25

(52) U.S. Cl. CPC A44B 11/258

(57) ABSTRACT

A buckle includes: a plug member including a shaft portion protruding to one end of a body, a locking jaw expanding from a front end of the shaft portion; and a first magnet embedded in the shaft portion; and a socket member including a coupling groove having an entrance formed at one side such that the shaft portion is inserted thereinto from one end of a body, an inclined guide surface formed at one side of the coupling groove, a second magnet embedded in the bottom surface of the coupling groove, and a locking portion formed on the inner circumference of the entrance of the opposite side to the inclined guide surface of the coupling groove to get in contact with the locking jaw when the shaft portion is inserted.

### CROSS-REFERENCE TO PRIOR APPLICATION

This application claims priority to Korean Patent Application No. 10-2022-0066501 filed on May 31, 2022, which is hereby incorporated by reference in its entirety.

### BACKGROUND

The present invention relates to a buckle, and more specifically, to a buckle including a socket member and a plug member, which are mounted on end portions of a belt or a strap attached to various articles, such as clothing, a bag, a backpack, a helmet, and the like, to be detachably coupled to each other, thereby having a very simple structure and being manipulated conveniently.

A buckle is a fastener for coupling and fixing two members to each other, is integrally molded of a plastic material to perform elastic coupling, and is widely used due to its lightness and easy manipulation.

A generally used buckle includes a plug member and a socket member, wherein the socket member has a chamber therein, and the plug member has a lock arm elastically coupled to the chamber to be coupled thereto.

However, the conventional buckle has a pair of the lock arms having a complex structure, the chamber of the socket member for receiving the pair of lock arms to be coupled to the lock arms, and a coupling structure disposed in the chamber, and so, requires considerable technical skills in manufacturing the buckle due to the complicated configuration.

Moreover, the conventional buckle is connected when a user holds the plug member and the socket member with both hands and couples them with each other, and is released from the connected state by pressing the lock arms of the plug member while holding the plug member and the socket member with two hands. That is, the conventional buckle is connected when the user accurately couples the plug member and the socket member with the two hands.

In a case in which a user manipulates a blet or a strap mounted on a backpack that the user wears for hiking, tracking, or the like, the user has to stop all other motions and use the two hands to couple the plug member and the socket member of the buckle, and has to put down things of the hands. So, people need a buckle capable of being coupled and manipulated simply.

Recently, in order to solve the above-described problem, a magnetic buckle capable of being coupled simply has been proposed.

In order to solve such a problem, the inventor of the present invention has proposed magnetic buckles disclosed in Korean Patent Nos. 10-1747187 and 10-2209939. The magnetic buckles disclosed in Korean Patent Nos. 10-1747187 and 10-2209939 have magnets without lock arms for coupling the plug member and the socket member with each other so that the plug member and the socket member can be coupled with each other by strong magnetic force by approaching each other, thereby providing convenience through simple coupling.

The two patent inventions provide convenience through the simple coupling, but has disadvantages in that it is difficult to separate the plug member and the socket member from each other or in that productivity is poor due to a relatively complicated configuration.

Therefore, people need a buckle capable of providing convenience through a simple manipulation, maintaining the coupled state stably, and improving productivity due to a simple configuration.

### SUMMARY

Accordingly, the present invention has been made to solve the above-mentioned problems occurring in the prior arts, and it is an object of the present invention to provide a buckle applied to various belts, straps or the likes, in which a plug member and a socket member are easily attached and detached, and which has a simple configuration to improve productivity.

It is another object of the present invention to provide a buckle capable of coupling the plug member and the socket member with each other just by approaching them and allowing a user to easily uncouple the plug member and the socket member from each other with one hand.

It is another object of the present invention to provide a buckle capable of stably maintaining a state in which the plug member and the socket member are coupled.

It is another object of the present invention to provide a buckle to which components, such as a buckle, a ring, a whistle, a strap fixture, a hook, or the like, with various shapes and functions can be attached, thereby being utilized widely.

To accomplish the above object, according to the present invention, there is provided a buckle including: a plug member including a shaft portion protruding to one end of a body, a locking jaw expanding from a front end of the shaft portion; and a first magnet embedded in the shaft portion; and a socket member including a coupling groove having an entrance formed at one side such that the shaft portion is inserted thereinto from one end of a body, an inclined guide surface formed at one side of the coupling groove, a second magnet embedded in the bottom surface of the coupling groove, and a locking portion formed on the inner circumference of the entrance of the opposite side to the inclined guide surface of the coupling groove to get in contact with the locking jaw when the shaft portion is inserted, wherein the plug member and the socket member are detachably coupled with each other.

Moreover, the front end of the shaft portion may have an inclined surface of a curved surface or a conical shape.

Furthermore, the entrance of the coupling groove on which the inclined guide surface is formed may be formed in a rectilinear shape, and the other side may be formed in a curved shape.

Additionally, the locking jaw of the shaft portion may be formed in a circular shape, and the locking portion with which the locking jaw gets in contact may have a portion having a curvature different from that of the locking jaw.

In addition, the inclined guide surface may range from the bottom surface of the coupling groove to one side of the entrance of the coupling groove.

Moreover, an opening may be formed at an end inside the coupling groove on the side of the body.

Furthermore, when the shaft portion is inserted into the coupling groove and the first magnet and the second magnet approach each other to be coupled with each other by their magnetic force, any one end of the locking jaw may be vertically overlapped with the locking portion so that the plug member is not separated from the socket member in the vertical direction.

Additionally, the second magnet may be arranged to be eccentric at one side from an open portion of the entrance of the coupling groove.

In addition, the center of the first magnet may do not match the center of the second magnet and get eccentric when the shaft portion is inserted into the entrance of the coupling groove.

Moreover, the first magnet and the second magnet may move horizontally to be coupled with each other by matching their centers when the shaft portion is completely inserted into the entrance of the coupling groove.

Furthermore, the buckle according to the present invention may further include a cross bar and a strap hooking bar selectively formed on one side of the body of the plug member or the socket member to connect a strap or a suspender thereto.

Additionally, the buckle according to the present invention may further include a rail holder disposed at one side of the body of the plug member or the socket member.

In addition, the buckle according to the present invention may further include a connection member formed integrally with one side of the body of the plug member or the socket member to connect any one selected from a ring, a clip, a hook, a connection buckle, a strap connector to the buckle.

Moreover, the buckle according to the present invention may further include a whistle attached to one side of the body of the plug member or the socket member.

Furthermore, the buckle according to the present invention may further include a flat type connection portion formed on at least one side of the body of the plug member or the socket member to be mounted on a bag or a strap.

The buckle according to the present invention has a simple configuration since the plug member and the socket member are coupled with each other by magnets instead of lock arms, thereby increasing productivity and reducing manufacturing costs.

The buckle according to the present invention provides convenience in coupling and uncoupling since the plug member having the magnet and the socket member having the magnet are coupled with each other by induction of strong magnetic force just by approaching each other, thereby stably maintaining the coupled state of the plug member and the socket member.

In addition, the buckle according to the present invention can be utilized widely since components, such as a buckle, a ring, a whistle, a strap fixture, a hook, or the like, with various shapes and functions can be attached to the buckle.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 to 11 are views illustrating a buckle according to an embodiment of the present invention, wherein

FIG. 1 is a view illustrating an example in which a buckle according to an embodiment of the present invention is mounted on a backpack;

FIG. 2 is a perspective view illustrating a coupled state of the buckle;

FIG. 3 is an exploded perspective view of the buckle;

FIG. 4 is a partially cross-sectional view of an uncoupled state of the buckle;

FIG. 5 is a cross-sectional view taken along the line A-A of FIG. 2;

FIG. 6 is a cross-sectional view taken along the line B-B of FIG. 2;

FIG. 7 is a cross-sectional view illustrating the uncoupled state of FIG. 6;

FIG. 8 is a plan view of a socket member;

FIG. 9 is a view illustrating an operational state in which the buckle is coupled;

FIG. 10 is a plan view of the socket member of FIG. 9(d); and

FIG. 11 illustrates an operational state in which the buckle is uncoupled, and

FIGS. 12 and 13 are views illustrating a buckle according to another embodiment of the present invention, wherein and

FIG. 12 is an exploded perspective view of the buckle;

FIG. 13 is a cross-sectional view showing a coupled state of the buckle.

### DETAILED DESCRIPTION

Hereinafter, various embodiments will be described in detail with reference to the accompanying drawings. The embodiments described below may be modified in a variety of different forms. In order to more clearly describe the features of the embodiments, details of well-known features and techniques may be omitted in view of the matters widely known to a person skilled in the art to which the following embodiments belong. In addition, parts irrelevant to description are omitted in the drawings in order to clearly explain embodiments of the present invention. Similar parts are denoted by similar reference numerals throughout this specification.

Further, wordings to be described later are defined in consideration of the functions of the present invention, and may differ depending on the intentions of a user or an operator or custom. Accordingly, such wordings should be defined on the basis of the contents of the overall specification.

Hereinafter, embodiments will be described in detail with reference to the accompanying drawings.

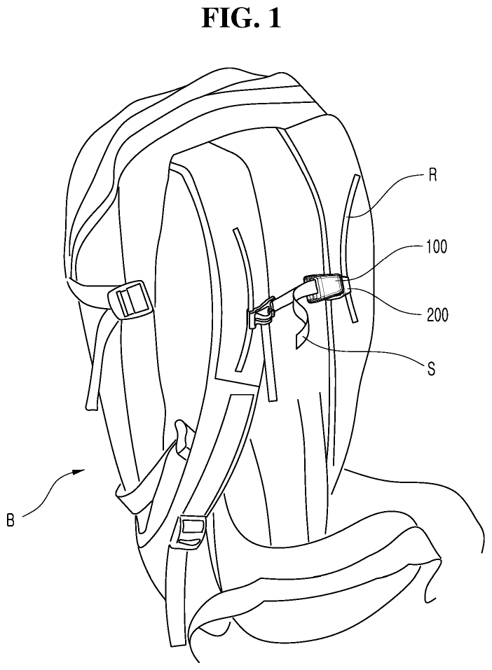

FIGS. 1 to 11 illustrate a buckle according to a first embodiment of the present invention, which is applied to a backpack.

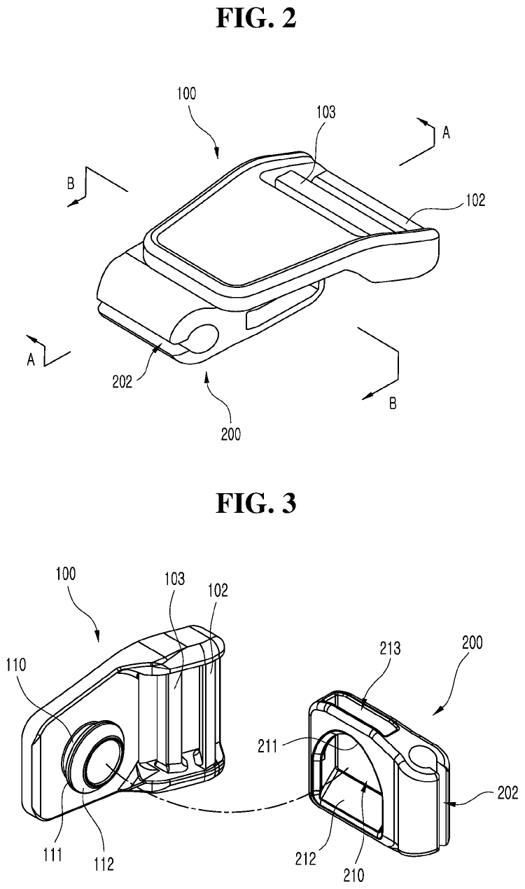

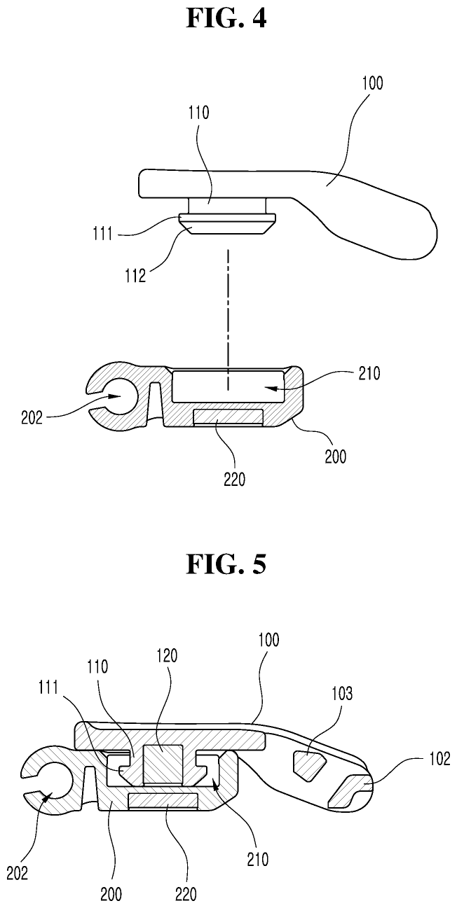

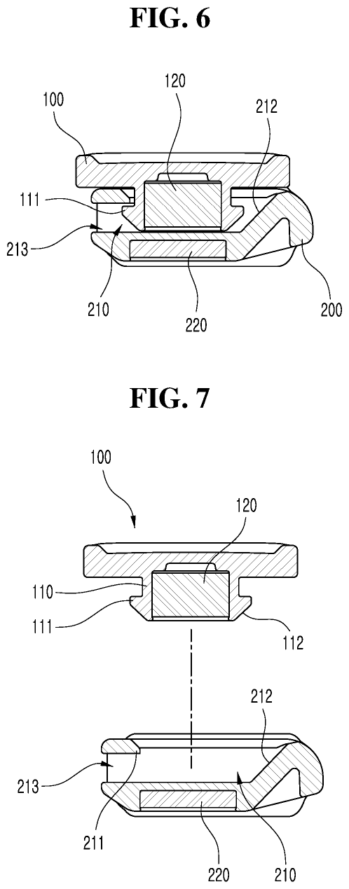

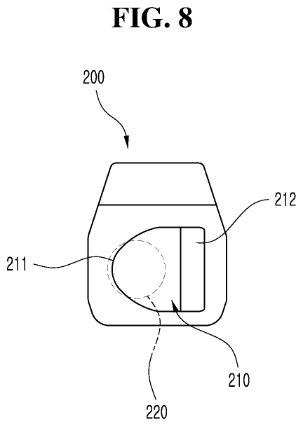

FIG. 1 is a view illustrating an example in which a buckle according to an embodiment of the present invention is mounted on a backpack, FIG. 2 is a perspective view illustrating a coupled state of the buckle, FIG. 3 is an exploded perspective view of the buckle, FIG. 4 is a partially cross-sectional view of an uncoupled state of the buckle, FIG. 5 is a cross-sectional view taken along the line A-A of FIG. 2, FIG. 6 is a cross-sectional view taken along the line B-B of FIG. 2, FIG. 7 is a cross-sectional view illustrating the uncoupled state of FIG. 6, and FIG. 8 is a plan view of a socket member.

Referring to FIGS. 1 to 8, the buckle according to the present invention includes a plug member 100 and a socket member 200 which are detachably connected to each other, and are generally molded of synthetic resin, and are applied to a backpack B or the like to be connected to a strap S.

FIG. 1 illustrates that the buckle according to the embodiment of the present invention is applied to a suspender of a backpack B, and is an elevation buckle in which the plug member 100 is connected to the strap S and the socket member 200 is connected to a rail portion R.

The plug member 100 includes a cross bar 102 and a strap hooking bar 103 horizontally formed at one side of a body so that a free end portion of the strap S is hooked and connected thereto. So, a user can adjust the length of the strap S by winding the strap S on the cross bar 102 and the strap hooking bar 103 on the cross.

The plug member 100 has a shaft portion 110 protruding from one side of the body, and a first magnet 120 is embedded in the shaft portion 110.

The shaft portion 110 has a locking jaw 111 formed on the front end thereof to be expand outwards with respect to the shaft portion.

Here, it is preferable that the locking jaw 111 is formed in a circular shape at the front end of the shaft portion 110.

A conically inclined surface 112 is formed at the front end of the locking jaw 111, and the inclined surface 112 is formed as a curved surface.

The socket member 200 has a rail holder 202 formed at one side of a body and fit to the rail portion R of the backpack B to be elevated on the backpack.

Alternatively, the socket member 200 may further include a strap hook bar like the plug member 100 to adjust the length of the strap.

The socket member 200 has a coupling groove 210 for accommodating the shaft portion 110 of the plug member 100, and a second magnet 220 is embedded in the bottom surface of the coupling groove 210.

Accordingly, in a case in which the plug member 100 and the socket member 200 are adjacent to each other, the shaft portion 110 of the plug member 100 is instantaneously inserted into the coupling groove 210 of the socket member 200 by the magnetic force of the first magnet 120 of the plug member 100 and the second magnet 220 of the socket member 200, and the front end of the shaft portion 110 is attached to the bottom surface of the coupling groove 210, so that the plug member 100 and the socket member 200 are coupled with each other.

An entrance of the coupling groove 210 is formed as big as the front end of the shaft portion 110, namely, the locking jaw 111, can be inserted thereinto or removed therefrom, and has an inclined guide surface 212 extending from one side of the entrance to the bottom surface of the coupling groove 210.

Accordingly, an entrance of the coupling groove 210 of a portion where the inclined guide surface 212 is formed is formed in a rectilinear shape, and a peripheral portion of the opposite entrance is formed in a curved shape and has a locking portion 211. That is, the entrance of the coupling groove 210 is expanded toward the inclined guide surface 212 so that the shaft portion 110 can be easily inserted thereinto.

Here, the locking portion 211 may be formed in a rectilinear shape.

The inclined guide surface 212 functions to guide the shaft portion 110 of the inserted plug member 100 to the inside of the coupling groove 210, and also functions to guide when the shaft portion 110 of the plug member 100 is drawn out.

The locking jaw 111 of the shaft portion 110 of the plug member 100 inserted into the coupling groove 210 of the socket member 200 is caught to the locking portion 211 inside the entrance so as not to be separated in a vertical direction, so that the shaft portion 110 of the plug member 100 can be drawn out while moving toward the inclined guide surface 212.

The above action is achieved since the shaft portion 110 moves to the opposite side of the inclined guide surface 212 to be attached while being inserted into the coupling groove 210.

Therefore, the locking jaw 111 and the locking portion 211 function as a fixing means together with the magnets to prevent uncoupling of the buckle.

As illustrated in FIG. 8, the second magnet 220 embedded in the bottom surface of the coupling groove 210 is eccentrically disposed at one side from the open portion of the entrance. Therefore, when the central portions of the first magnet 120 and the second magnet 220 are attached to each other, the locking jaw 111 is located inside the peripheral portion of the entrance, so that the locking jaw 111 and the locking portion 211 are overlapped with each other not to be separated from each other in the vertical direction.

In order to more efficiently form the retained state of the locking jaw 111 and the locking portion 211, the locking jaw 111 is formed in a circular shape, and the locking portion 211 has a curvature different from the curvature of the locking jaw 111 or has a rectilinear inner circumference. Of course, the locking jaw 11 may have an oval shape or a polygonal shape as well as the circular shape. That is, the locking jaw 111 may have any shape if the locking jaw 111 can be vertically caught to the locking portion 211 in a state in which the plug member 100 and the socket member 200 are coupled with each other.

The socket member 200 has an opening 213 formed at one side of the body from one side in the coupling groove 210.

As illustrated in the drawing, the opening 213 is formed in the coupling groove 210 in a different direction to the inclined guide surface 212.

The opening 213 functions to easily discharge foreign substances which may be introduced into the coupling groove 210.

The opening 213 prevents the shaft portion 110 from being hindered in insertion into the coupling groove 210 by pressure generated in the coupling groove 210 by the shaft portion 110 instantaneously inserted by magnetic force.

Now, the operation of the buckle according to the above configuration will be described.

In a case in which the plug member 100 and the socket member 200 come into close to each other, the first magnet 120 and the second magnet 220 are instantaneously attracted to each other by their magnetic force so that the plug member 100 and the socket member 200 are tightly coupled.

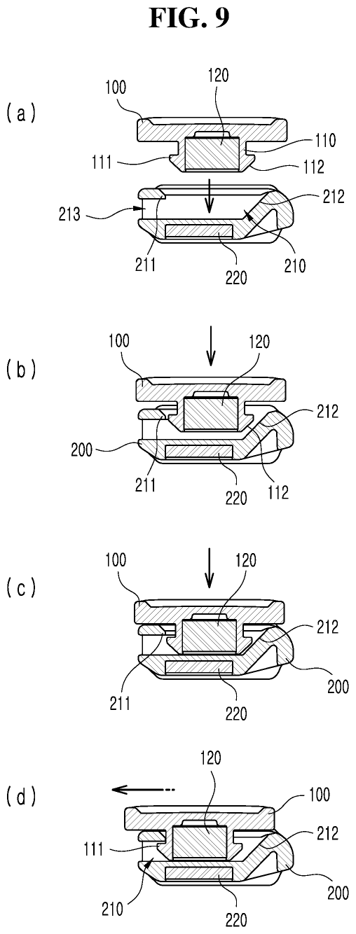

FIG. 9(a) to FIG. 9(d) sequentially illustrate cross-sectional states in which the plug member 100 and the socket member 200 are coupled to each other.

FIG. 9(a) illustrates a state in which the plug member 100 and the socket member 200 approach each other, FIG. 9(b) illustrates a state in which the shaft portion 110 and the locking jaw 111 enter the coupling groove 210, FIG. 9(c) illustrates a state in which the front end of the shaft portion 110 goes to the bottom surface of the coupling groove 210, and FIG. 9(d) illustrates a state in which the plug member 100 and the socket member 200 move horizontally toward the centers of the magnets by the magnetic force in a state in which the shaft portion 110 is inserted.

The steps of FIGS. 9(a) to 9(d) are instantaneously achieved by the strong magnetic force.

Referring to FIG. 9, when the plug member 100 and the socket member 200 are close to each other, the shaft portion 110 is inserted into the entrance of the coupling groove 210 by the strong magnetic force. In this instance, the first magnet 120 and the second magnet 220 are in an eccentric state that the center of the first magnet 120 does not match the center of the second magnet 220. When the shaft portion 110 is completely inserted into the coupling groove 210, as illustrated in FIG. 9(d), the first magnet 120 and the second magnet 220 horizontally move to match their centers so that the plug member 100 and the socket member 200 are coupled with each other finally. In the above coupled state, one end of the locking jaw 111 is overlapped with the locking portion 211 to maintain the coupled state of the buckle.

In the above process, one side of the front end of the shaft portion 110 may get in contact with the inclined guide surface 212, and the front end of the shaft portion 110 has a conical inclined surface 112 or a curved surface so as to get in contact with the inclined guide surface 212 more smoothly. Collision or contact with the inclined guide surface 212 facilitates the coupling when the shaft portion 110 is moved to the inside of the coupling groove 210 more quickly.

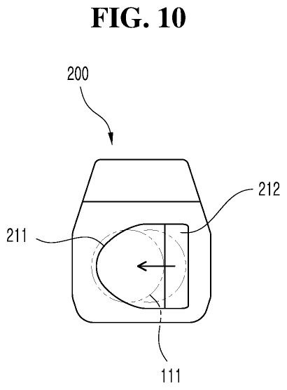

FIG. 10 is a plan view different from FIG. 9, illustrating the position of the locking jaw 111 when the plug member and the socket member are coupled with each other.

Referring to FIG. 10, when the plug member 100 moves horizontally by the magnetic force to be completely coupled to the socket member 200 after the shaft portion 110 is completely inserted into the coupling groove 210 as illustrated in FIG. 9(d), a portion of the locking jaw 111 is overlapped with the locking portion 211.

In the coupled state, in a case in which a user simply pulls or raises the plug member 100 and the socket member 200 in the vertical direction, the plug member 100 and the socket member 200 are not separated from each other due to the coupling relationship between the locking jaw 111 and the locking portion 211.

Therefore, the buckle according to the present invention prevents the plug member 100 and the socket member 200 from being separated in the vertical direction due to the magnetic force of the first magnet 120 and the second magnet 220 and the retained state of the locking jaw 111 and the locking portion 211, and the plug member 100 and the socket member 200 can be separated from each other only when the plug member 100 is moved toward the inclined guide surface 212.

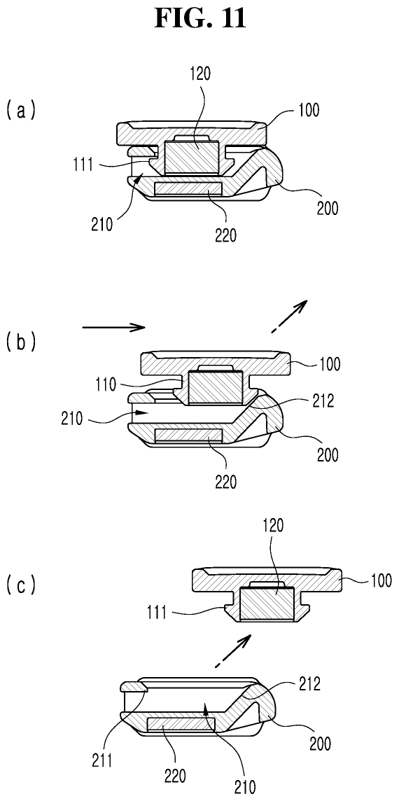

FIGS. 11(a) to 11(c) are cross-sectional views illustrating an operation that the plug member 100 and the socket member 200 are separated from each other.

FIG. 11(a) illustrates a state in which the plug member 100 and the socket member 200 are coupled, FIG. 11(b) illustrates a state in which the shaft portion 110 is separated from the coupling groove 210 along the inclined guide surface 212, and FIG. 11(c) illustrates a state in which the plug member 100 and the socket member 200 are completely separated from each other.

As illustrated in FIG. 11, when the user pushes the plug member 100 toward the inclined guide surface 212 with one hand, the inclined surface 112 of the front end of the shaft portion 110 is guided to come into contact with the inclined guide surface 212 such that the shaft portion 110 is naturally separated from the coupling groove 210 so that the plug member 100 and the socket member 200 are easily separated from each other.

As described above, since the plug member 100 and the socket member 200 can be instantly coupled with each other by the magnets, the user can connect a belt, a strap or the like with one hand, and also can simply uncouple the buckle with one hand.

The buckle according to the present invention can be coupled and uncoupled simply and can maintain the coupled state unless the user does not manipulate the plug member and the socket member intentionally. So, the user can use the buckle in safety.

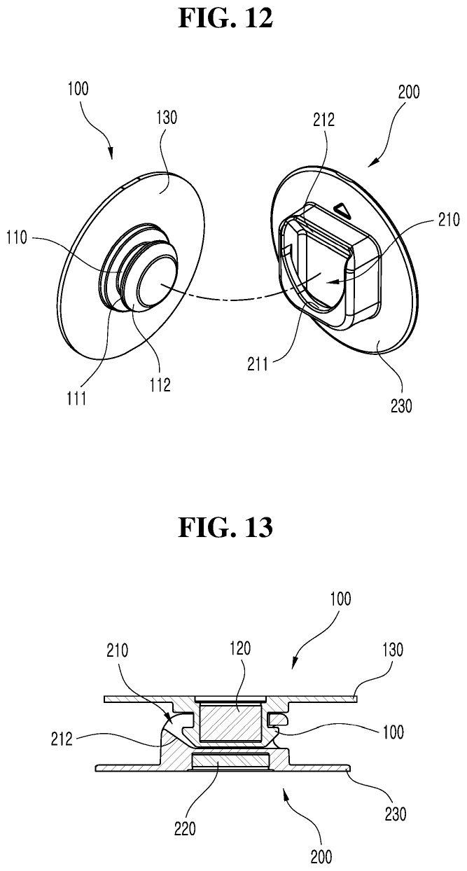

FIGS. 12 and 13 illustrate a buckle according to another embodiment of the present invention, which is a flat type buckle for opening and closing a bag. For instance, the socket member 200 is attached to a main body of a bag, and the plug member 100 is attached to a flat surface of a bag cover to be used as an opening and closing means.

In this case, in order to mount the buckle on the bag by sewing, the plug member 100 has a flat type connection portion 130 formed on the body thereof, and the socket member 200 also has a flat type connection portion 230 formed on the body thereof.

The connection portions 130 and 230 are fixed and adhered by sewing or adhesion. Accordingly, the buckle can easily open and close the bag due to the magnetic force of the first magnet 120 and the second magnet 220 and the coupling of the locking jaw 111 and the locking portion 211.

Besides the above, the buckle according to the present invention may have connection members, such as a hook, a ring, a clip, a connection buckle, a strap connector and the like, or means for connecting articles, such as a whistle and the like, which may be applied to one side of the body.

The above description is only exemplary, and it will be understood by those skilled in the art that the invention may be embodied in other concrete forms without changing the technological scope and essential features. Therefore, the above-described embodiments should be considered only as examples in all aspects and not for purposes of limitation. For example, each component described as a single type may be realized in a distributed manner, and similarly, components that are described as being distributed may be realized in a coupled manner.

The scope of the present invention is defined by the appended claims, and encompasses all modifications or alterations derived from meanings, the scope and equivalents of the appended claims.

What is claimed is:

1. A buckle comprising:
a plug member including a shaft portion protruding to one end of a body, a locking jaw expanding from a front end of the shaft portion; and a first magnet embedded in the shaft portion; and
a socket member including a coupling groove having an entrance formed at one side such that the shaft portion is inserted thereinto from one end of a body, an inclined guide surface formed at one side of the coupling groove, a second magnet embedded in the bottom surface of the coupling groove, and a locking portion formed on the inner circumference of the entrance of the opposite side to the inclined guide surface of the coupling groove to get in contact with the locking jaw when the shaft portion is inserted,
wherein the plug member and the socket member are detachably coupled with each other.

2. The buckle according to claim 1, wherein the front end of the shaft portion has an inclined surface of a curved surface or a conical shape.

3. The buckle according to claim 1, wherein the entrance of the coupling groove on which the inclined guide surface is formed is formed in a rectilinear shape, and the other side is formed in a curved shape.

4. The buckle according to claim 1, wherein the locking jaw of the shaft portion is formed in a circular shape, and the locking portion with which the locking jaw gets in contact has a portion having a curvature different from that of the locking jaw.

5. The buckle according to claim 1, wherein the inclined guide surface ranges from the bottom surface of the coupling groove to one side of the entrance of the coupling groove.

6. The buckle according to claim 1, wherein an opening is formed at an end inside the coupling groove on the side of the body.

7. The buckle according to claim 1, wherein when the shaft portion is inserted into the coupling groove and the first magnet and the second magnet approach each other to be coupled with each other by their magnetic force, any one end of the locking jaw is vertically overlapped with the locking portion so that the plug member is not separated from the socket member in the vertical direction.

8. The buckle according to claim 1, wherein the second magnet is arranged to be eccentric at one side from an open portion of the entrance of the coupling groove.

9. The buckle according to claim 1, wherein the center of the first magnet does not match the center of the second magnet and gets eccentric when the shaft portion is inserted into the entrance of the coupling groove.

10. The buckle according to claim 9, wherein the first magnet and the second magnet move horizontally to be coupled with each other by matching their centers when the shaft portion is completely inserted into the entrance of the coupling groove.

11. The buckle according to claim 1, further comprising:
a cross bar and a strap hooking bar selectively formed on one side of the body of the plug member or the socket member to connect a strap or a suspender thereto.

12. The buckle according to claim 1, further comprising:
a rail holder disposed at one side of the body of the plug member or the socket member.

13. The buckle according to claim 1, further comprising:
a connection member formed integrally with one side of the body of the plug member or the socket member to connect any one selected from a ring, a clip, a hook, a connection buckle, a strap connector to the buckle.

14. The buckle according to claim 1, further comprising:
a whistle attached to one side of the body of the plug member or the socket member.

15. The buckle according to claim 1, further comprising:
a flat type connection portion formed on at least one side of the body of the plug member or the socket member to be mounted on a bag or a strap.
